(19) United States
(12) Patent Application Publication
(10) Pub. No.: US 2011/0050988 A1
(43) Pub. Date: Mar. 3, 2011

(54) Optical element module and manufacturing method thereof, electronic element module and manufacturing method thereof, and electronic information device

(75) Inventors: Yuji Yano, Osaka (JP); Hiroshi Yokota, Osaka (JP); Yoshiaki Fujimoto, Osaka (JP)

(73) Assignee: Sharp Kabushiki Kaisha, Osaka (JP)

(21) Appl. No.: 12/805,960

(22) Filed: Aug. 26, 2010

(30) Foreign Application Priority Data
Aug. 28, 2009 (JP) 2009-199013

(51) Int. Cl. H04N 5/225; G02B 9/00; B23P 11/00

(52) U.S. Cl. 348/374; 359/738; 29/428; 348/E05.024

(57) ABSTRACT

An optical element module according to the present invention is provided, in which: one or a plurality of optical elements are housed within a light shielding holder; a slanting surface is provided on an outer circumference side of an optical surface of the optical element facing an aperture opening of the light shielding holder; a slanting surface is provided on an inner surface on a back side of the aperture opening of the light shielding holder in such a manner to face the slanting surface of the optical element; and the slanting surface of the optical element and the slanting surface of the light shielding holder are guided together, so that the aperture opening of the light shielding holder and the optical surface of the optical element are positioned.

This nonprovisional application claims priority under 35 U.S.C. §119(a) to Patent Application No. 2009-199013 filed in Japan on Aug. 28, 2009, the entire contents of which are hereby incorporated by reference.

### BACKGROUND OF THE INVENTION

1. Field of the Invention

The present invention relates to: an optical element module, such as a lens module and an optical function element module, in which one or a plurality of optical elements are housed within a light shielding holder, and a manufacturing method thereof; an electronic element module obtained by modularizing the optical element module and an electronic element, and a manufacturing method thereof; and an electronic information device, such as a digital camera (e.g., a digital video camera or a digital still camera), an image input camera (e.g., a monitoring camera), a scanner, a facsimile machine, a television telephone device and a camera-equipped cell phone device, including the electronic element module as an image input device used in an image capturing section thereof.

2. Description of the Related Art

In some conventional lens units used for a camera module or the like, concave and convex parts provided for adjacent lenses are engaged with each other to position a plurality of lenses in a lens tube.

FIG. 14 is a longitudinal cross sectional view of a conventional lens unit disclosed in Reference 1.

As illustrated in FIG. 14, a conventional lens unit 100 is manufactured as follows: an aperture opening 101a is placed upside down and a first lens 102 is first inserted into a lens tube 101, which is a circular shape in plan view; and next, a second lens 103 is inserted into a concave part of the first lens 102. A convex part slanting surface 102a, which is a circumference of the concave part of the first lens 102, contacts with a concave part slanting surface 103a, which is a convex part side wall of the second lens 103, to be positioned surface to surface. Thus, the positioning of the first lens 102 and the second lens 103 with each other enables to control the misalignment of the optical axis of the lenses, and the space between the lenses in an optical axis direction accurately.

Reference 1: Japanese Laid-Open Publication No. 2009-139693

### SUMMARY OF THE INVENTION

In the conventional lens unit 100 described above, however, there may be a case as illustrated in FIG. 15. That is, if an adsorbing jig 104 for conveying the second lens 103 tilts during the insertion of the second lens 103 into the concave part of the first lens 102, the convex part slanting surface 102a and the concave part slanting surface 103a will not contact each other on their slanting surfaces. This will result in the second lens 103 to be fixed tilting relative to the first lens 102. As a result, the space between the lenses will not be stabilized and there will be misalignment or tilting from an optical axis C to an optical axis C1 on an optical surface, which may cause problems such as the decrease or variation in the optical characteristics.

Moreover, since there is a space between the exterior wall of the first lens and the lens tube, there will be a positional misalignment between the center of the aperture opening 101a of the lens tube 101 and the optical axis C of the optical surface of the first lens 102.

The present invention is intended to solve the conventional problems described above. The objective of the present invention is to provide: an optical element module, such as a lens unit, capable of preventing the misalignment and tilting of the lens optical axis C relative to the aperture opening of the lens tube and the center of the aperture opening to make the optical characteristics favorable, and a manufacturing method thereof; an electronic element module, such as a camera module, using the lens unit, and manufacturing method thereof; and an electronic information device, such as a camera-equipped cell phone device, including the electronic element module as an image input device used in an image capturing section.

An optical element module according to the present invention is provided, in which: one or a plurality of optical elements are housed within a light shielding holder; a slanting surface is provided on an outer circumference side of an optical surface of the optical element facing an aperture opening of the light shielding holder; a slanting surface is provided on an inner surface on a back side of the aperture opening of the light shielding holder in such a manner to face the slanting surface of the optical element; and the slanting surface of the optical element and the slanting surface of the light shielding holder are guided together, so that the aperture opening of the light shielding holder and the optical surface of the optical element are positioned, thereby achieving the objective described above.

Preferably, in an optical element module according to the present invention, a spacer section is provided on the outer circumference side of the optical surface of the optical element facing the aperture opening of the light shielding holder, with a slanting surface interposed from a planarized section; a planarized bottom surface is provided on an inner surface of a back side of the aperture opening of the light shielding holder, with an interposed slanting surface facing the slanting surface of the optical element; and the slanting surface of the optical element is guided by the slanting surface of the light shielding holder, so that the bottom surface contacts the spacer section of the optical element.

Still preferably, in an optical element module according to the present invention, a spacer section is provided on the outer circumference side of the optical surface of the optical element facing the aperture opening of the light shielding holder, with a slanting surface interposed from a planarized section; a planarized bottom surface is provided on an inner surface of a back side of the aperture opening of the light shielding holder, with an interposed slanting surface facing the slanting surface of the optical element; and the slanting surface of the optical element is guided by the slanting surface of the light shielding holder, so that the bottom surface contacts a planarized section on an outer circumference side of the optical surface.

Still preferably, in an optical element module according to the present invention, the slanting surface is an annular slanting surface.

Still preferably, in an optical element module according to the present invention, the annular slanting surface of the optical element forms a concave section, and the annular slanting surface of the light shielding holder forms a convex section.

Still preferably, in an optical element module according to the present invention, the annular slanting surface of the optical element forms a convex section, and the annular slanting surface of the light shielding holder forms a concave section.

Still preferably, in an optical element module according to the present invention, the annular slanting surface of the optical element and the annular slanting surface of the light shielding holder slant 30 to 80 degrees relative to the planarized surface.

Still preferably, in an optical element module according to the present invention, the annular slanting surface of the optical element and the annular slanting surface of the light shielding holder slant 45 to 60 degrees relative to the planarized surface.

Still preferably, in an optical element module according to the present invention, there is a gap of 30 μm to 100 μm between an inner surface of the light shielding holder and an outer surface of the one or plurality of optical elements, which are quadrilateral in plan view.

Still preferably, in an optical element module according to the present invention, a gap between the annular slanting surface of the optical element and the annular slanting surface of the light shielding holder is 20 μm at its maximum.

Still preferably, in an optical element module according to the present invention, an adhesive is arranged only in a space portion surrounded by bottom sections provided, with interposed taper sections, on a further outer circumference side of respective planarized surfaces of the spacer section on the outer circumference side of the optical surface on a back surface of an upper optical element, and a spacer section on the outer circumference side of the optical surface on a front surface of a lower optical element, so that the upper optical element and the lower optical element are adhered with each other.

Still preferably, in an optical element module according to the present invention: the adhesive is arranged only in the space portion surrounded by the bottom sections with the interposed taper sections; the adhesive is not arranged at least in a space portion surrounded by the upper and lower taper sections; and at least the space portion surrounded by the taper sections has enough space which prevents the adhesive from spreading to the spacer section by being pressed by the upper optical element and the lower optical element during adhesion.

Still preferably, in an optical element module according to the present invention, among the plurality of optical elements, a lens space between the upper optical element and the lower optical element is defined, together with an overall thickness, by direct contacting of the respective planarized surfaces of the spacer section of the upper optical element and the spacer section of the lower optical element.

Still preferably, in an optical element module according to the present invention, among the plurality of optical elements, a light shielding plate is interposed between at least the respective planarized surfaces of the spacer section of the upper optical element and the spacer section of the lower optical element.

Still preferably, in an optical element module according to the present invention, the light shielding plate includes an opening, which is provided at a position corresponding to the optical surface of the optical element, and includes a cut section, which is formed by cutting off part of an outer circumference edge thereof.

Still preferably, in an optical element module according to the present invention, the cut section is either provided at four sides of a quadrilateral in plan view excluding corner portions thereof, or formed at four corner portions thereof.

Still preferably, in an optical element module according to the present invention, the cut section at the four corner portions is either in a ¼ circular shape, or in an L shape along the corner portion.

Still preferably, in an optical element module according to the present invention, the optical surface, the slanting surface on the outer circumference side thereof, and the spacer section are simultaneously formed with a transparent resin material.

Still preferably, in an optical element module according to the present invention, the optical element is a lens.

Still preferably, in an optical element module according to the present invention, the optical element is an optical function element that directs output light straight to be output and refracting and guiding incident light in a predetermined direction.

A method for manufacturing an optical element module according to the present invention is provided for manufacturing the optical element module according to the present invention, the method including an assembling step, in which an optical element module is inserted into an open side of the light shielding holder, from the side close to the upper most optical element of the optical element module, and owing to a weight of the optical element module itself, a slanting surface of the uppermost optical element and a slanting surface on an inner side of an aperture opening of the light shielding holder are guided together, so that the aperture opening of the light shielding holder and the optical surface of the optical element are positioned, thereby achieving the objective described above.

Preferably, in a method for manufacturing an optical element module according to the present invention, the method further includes, prior to the assembling step:

a combing step for combing, by an adhesive, an upper lens wafer with a plurality of optical surfaces arranged thereon two dimensionally and a lower lens wafer with a plurality of optical surfaces arranged thereon two dimensionally, with a light shielding plate wafer interposed therebetween, in such a manner that optical axes of the upper and lower optical surfaces correspond to openings of the light shielding plate wafer, to manufacture an optical element wafer module; a UV light emitting step of emitting UV light onto the adhesive to cure the adhesive; and a cutting step of cutting the optical element wafer module simultaneously along dicing lines into individualized optical element modules.

An electronic element module according to the present invention is provided, in which an image capturing element chip module is fixed in a light shielding holder of the optical element module according to the present invention, the image capturing element chip module including a transparent support substrate adhered and fixed thereto to cover an electronic element facing the optical surface of the optical element, and the image capturing element chip module being adhered by positioning the electronic element relative to the optical surface, thereby achieving the objective described above.

A method for manufacturing an electronic element module according to the present invention is provided, the method including: an optical element module assembling step using the method for manufacturing an optical element module according to the present invention; and an electronic element chip module assembling step of fixing an electronic element chip module including a transparent support substrate adhered and fixed thereto for covering the electronic element, within the light shielding holder by positioning the electronic element facing the optical surface of the optical element, with the optical surface, thereby achieving the objective described above.

An electronic information device according to the present invention includes an electronic element module, as a sensor module, in an image capturing section thereof, the electronic element module including the optical element module according to the present invention provided therefor.

An electronic information device according to the present invention includes an electronic element module in an information recording and reproducing section thereof, the electronic element module including the optical element module according to the present invention provided therefor.

The functions of the present invention having the structures described above will be described hereinafter.

In the present invention, one or a plurality of optical elements are housed within a light shielding holder;

a slanting surface is provided on an outer circumference side of an optical surface of the optical element facing an aperture opening of the light shielding holder; a slanting surface is provided on an inner surface on a back side of the aperture opening of the light shielding holder in such a manner to face the slanting surface of the optical element; and the slanting surface of the optical element and the slanting surface of the light shielding holder are guided together, so that the aperture opening of the light shielding holder and the optical surface of the optical element are positioned.

As a result, the slanting surface of the first lens and the slanting surface inside the light shielding holder are guided together, so that the protruded slanting surface is engaged with the concaved slanting surface. This enables, for example, to position a lens module having a first lens and a second lens with high accuracy along an engaging section of a light shielding holder. As a result, it becomes possible to prevent the misalignment and tilting of the lens optical axis C relative to the aperture opening of the light shielding holder and the center of the aperture opening to make the optical characteristics favorable.

According to the present invention described above, the annular slanting surface of the first lens and the annular slanting surface of the light shielding holder are guided together, and the protruded annular slanting surface is engaged with the concaved annular slanting surface. Therefore, it becomes possible to position, for example, the lens module having the first lens and the second lens with high accuracy along the engaging section of the light shielding holder. As a result, it becomes possible to prevent the misalignment and tilting of the lens optical axis C relative to the aperture opening of the light shielding holder and the center of the aperture opening to make the optical characteristics favorable.

These and other advantages of the present invention will become apparent to those skilled in the art upon reading and understanding the following detailed description with reference to the accompanying figures.

### BRIEF DESCRIPTION OF THE DRAWINGS

FIG. 1 is a schematic external view of an electronic element module according to Embodiment 1, where FIG. 1(a) is a perspective view and FIG. 1(b) is a top view of the electronic element module.

FIG. 2 is a longitudinal cross sectional view illustrating an exemplary detailed structure of the electronic element module according to Embodiment 1.

FIG. 3(a) is a plan view illustrating a front surface of the first lens in FIG. 2, and FIG. 3(b) is a plan view illustrating a back surface of the first lens and front and back surfaces of a second lens in FIG. 2.

FIGS. 4(a) to 4(c) are each an essential part longitudinal cross sectional view illustrating each manufacturing step for modularizing a first lens wafer and a second lens wafer to manufacture a lens wafer module.

FIG. 5 is a cross sectional view of each member, illustrating an image capturing element module assembling step for housing a lens module and an image capturing element chip module within a light shielding holder.

FIG. 6 is a plan view illustrating an example of a first lens wafer.

FIG. 7 is a plan view illustrating an example of a light shielding plate wafer, where FIG. 7(a) is a view illustrating a case where a cut guiding hole is a rectangular hole, and FIG. 7(b) is a view illustrating a case where a cut guiding hole includes a cross shape hole and an L shape hole.

FIG. 8 is a plan view illustrating an example of a second lens wafer, where FIG. 8(a) illustrates a state where an adhesive is applied in accordance with a cut guiding hole of a light shielding plate wafer being a rectangular hole, and FIG. 8(b) illustrates a state where the adhesive is applied in accordance with the cut guiding hole of a light shielding plate wafer being a cross shape hole and an L shape hole.

FIGS. 9(a) and 9(b) are each a plan view illustrating a positional relationship between a cut guiding hole and a dicing line DL, for facilitating simultaneous cutting in a light shielding plate wafer in FIG. 7. FIG. 9(c) is an enlarged view of a rectangular hole in FIG. 9(a), and FIG. 9(d) is an enlarged view of a cross shape hole in FIG. 9(b).

FIG. 10 is a diagram for describing a case where a spacer of a first lens does not directly contact a spacer section of a second lens, and a case where a light shielding plate wafer is not interposed directly therebetween, where FIG. 10(a) is an essential part cross sectional view of a front surface shape of the first lens, FIG. 10(b) is an essential part cross sectional view of a back surface shape thereof in a case where the first lens is fixed by an adhesive on a glass plate, FIG. 10(c) is an essential part cross sectional view of a joint surface of the first lens and the second lens, FIGS. 10(d), 10(e) and 10(g) are each an essential part cross sectional view of a joint surface in a case where a light shielding plate is directly put between the first lens and the second lens, and FIG. 10(f) is an essential part cross sectional view of a joint surface in a case where the light shielding plate is directly put between a glass plate and the first lens.

FIG. 11 is a diagram for describing a case where a light shielding plate cut from a light shielding plate wafer in FIG. 7(b) is used and a case where it is not used, where FIG. 11(a) is an essential part cross sectional view of a lens joint surface of a case where a light shielding plate is not used, FIG. 11(b) is a plan view thereof, FIG. 11(c) is an essential part cross sectional view of a lens joint surface of a case where the light shielding plate is used, and FIG. 11(d) is a plan view thereof.

FIG. 12 is a longitudinal cross sectional view illustrating an exemplary detailed structure of an image capturing element module according to Embodiment 2.

FIG. 13 is a block diagram schematically illustrating an exemplary configuration of an electronic information device of Embodiment 3 of the present invention, using a solid-state image capturing apparatus including the sensor module according to Embodiment 1 or 2 of the present invention in an image capturing section.

FIG. 14 is a longitudinal cross sectional view of a conventional lens unit disclosed in Reference 1.

FIG. 15 is a longitudinal cross sectional view illustrating a case where a lens optical axis is tilted in a conventional lens unit in FIG. 14 during assembly.

400, 500 image capturing element module

401 image capturing element chip (electronic element chip)

402, 502 light shielding holder

402B, 406B, 502C, 506B slanting surface

403 image capturing element

404 resin adhesive layer

405 transparent support substrate

406, 506 first lens

406A, 506A planarized surface

406C, 406D, 407D, 506C spacer section

406E, 407E, 502D bottom surface section (bottom section)

407 second lens

408, 508 lens module

409 adhesive

409A vent hole

410, 410A to 410C, 410E light shielding plate

411a lens opening (through hole)

411b rectangular hole (rectangular shape hole)

411c cross shape hole

411d L shape hole

411e cut section

411, 411A, 411B light shielding plate wafer

412 image capturing element chip module

416 first lens wafer

417 second lens wafer

418 lens wafer module

420, 421 spacer section

A optical surface

B aperture opening

G contacting section

H adhesive section

90 electronic information device

91 solid-state image capturing apparatus

92 memory section

93 display section

94 communication section

95 image output section

### DESCRIPTION OF THE PREFERRED EMBODIMENTS

Hereinafter, cases will be described in detail with reference to the accompanying figures as Embodiments 1 and 2, where an optical element module and a manufacturing method thereof, and an electronic element module using the optical element module and a manufacturing method thereof according to the present invention are applied to a lens module and a manufacturing method thereof and a sensor module using the lens module and a manufacturing method thereof. Further, an electronic information device, such as a camera-equipped cell phone device, including the sensor module as an image input device used in an image capturing section will be described in detail with reference to the accompanying figures as Embodiment 3.

### Embodiment 1

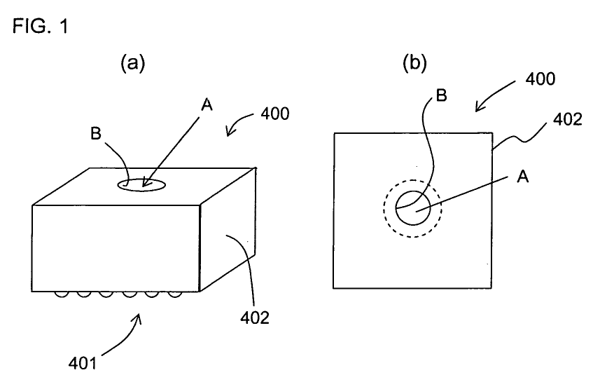

FIG. 1 is a schematic external view of an electronic element module 400 according to Embodiment 1, where FIG. 1(a) is a perspective view and FIG. 1(b) is a top view of the electronic element module 400.

As illustrated in FIGS. 1(a) and 1(b), the electronic element module 400 (sensor module 10) as the electronic element module according to Embodiment 1 includes: an optical element or an optical element module (not shown), such as one or a plurality of lenses, in which an optical surface A is provided at the center portion; and an image capturing element chip 401. The optical element or optical element module and the image capturing element chip 401 are housed within a light shielding holder 402 such that an optical surface A corresponds and aligns with an aperture opening B. By the light shielding holder 402, the top and side surfaces are covered, except the optical surface A, to shield the surface of the image capturing element from light. A plurality of the electronic element modules 400 are cut simultaneously from an image capturing element wafer module, and therefore, the external shape of each of the electronic element modules 400 is a quadrilateral in plan view as illustrated in FIG. 1(b).

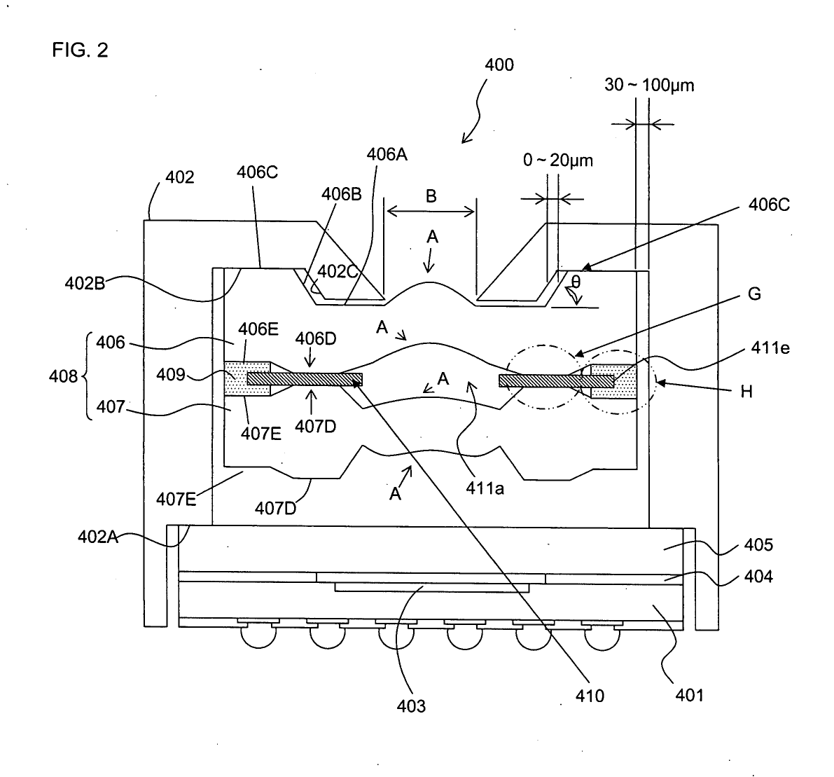

FIG. 2 is a longitudinal cross sectional view illustrating an exemplary detailed structure of the electronic element module 400 according to Embodiment 1.

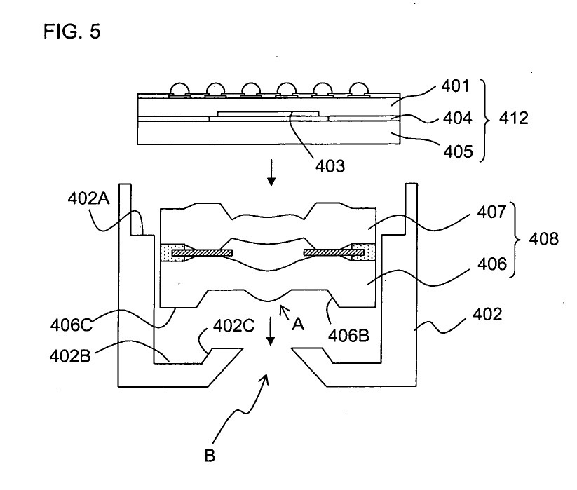

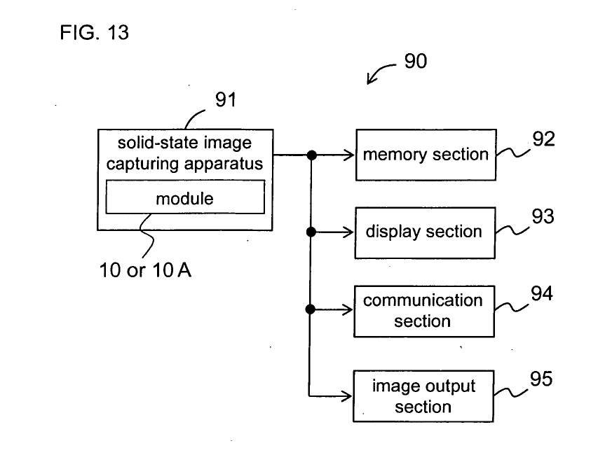

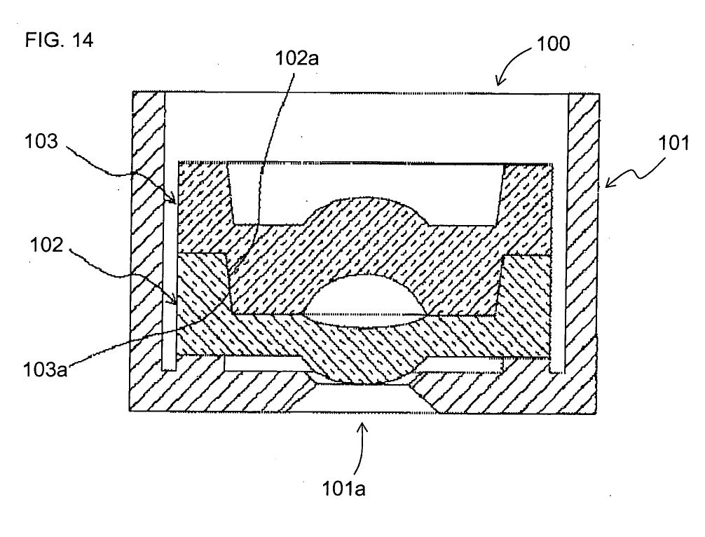

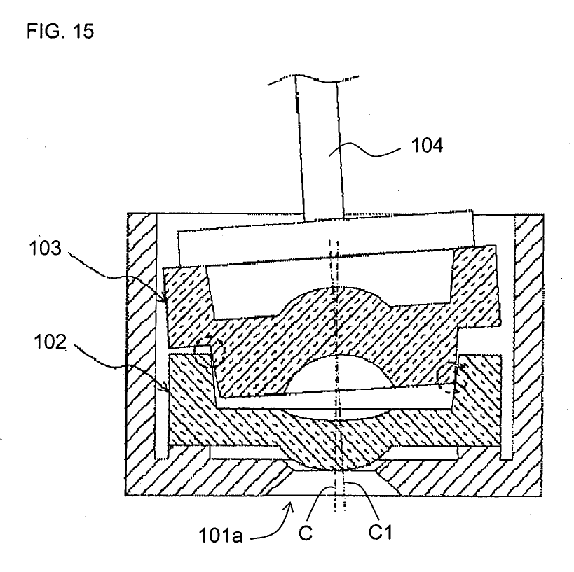

As illustrated in FIG. 2, the electronic element module 400 according to Embodiment 1 includes: an image capturing element chip 401 as an electronic element, in which an image capturing element 403 is arranged at the center portion, the image capturing element 403 having a plurality of light receiving sections for capturing an image of a subject; a resin adhesive layer 404 arranged in the periphery of the image capturing element 403 on the image capturing element chip 401; a transparent support substrate 405, such as a glass plate, covering the image capturing element 403 and being adhered on and fixed to the resin adhesive layer 404; and a lens module 408, as an optical element module including a first lens 406 and a second lens 407, provided above the transparent support substrate 405 in such a manner that the respective lens positions (position of respective optical surfaces A) correspond to and align with the image capturing element 403. The electronic element module 400 further includes a light shielding holder 402. The light shielding holder 402 arranges the image capturing element chip 401, the resin adhesive layer 404 and the transparent support substrate 405 below a step section 402A, and arranges the lens module 408 below a bottom surface section 402B, to shield external light except for image capturing light. FIG. 2 illustrates one unitary lens module 408 of a lens wafer module. As will be detailed later, the unitary lens module 408 is in fact made such that the lens wafer module is cut into a large number of individualized lens modules 408. The lens module 408 is housed within the light shielding holder 402 and an individualized electronic element (i.e., an image capturing element chip module 412, which will be described later with reference to FIG. 5) is arranged on the step section 402A within the light shielding holder 402, to manufacture the electronic element module 400 (i.e., a sensor module 10, which will be described with reference to FIG. 13).

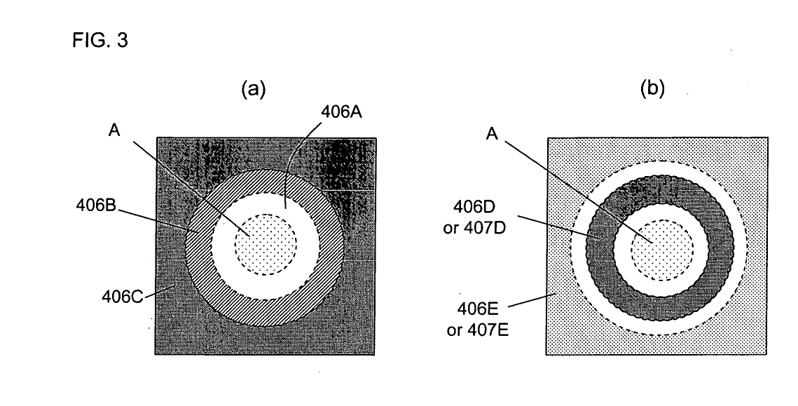

As illustrated in FIG. 3(a), the front surface of the first lens 406 of the lens module 408 includes a planarized spacer section 406C (a planarized section or a protruded section), which is annularly protruded to surround the optical surface A, with an outer circumference end portion, a planarized surface 406A and a slanting surface 406B interposed therebetween. In addition, as illustrated in FIG. 3(b), the back surface of the first lens 406 is provided with a bottom section 406E (or a bottom surface section) for arranging an adhesive thereon, on a further outer circumference side of a planarized spacer section 406D (protruded section), which is annularly protruded surrounding the optical surface A of the center portion, with a step section (a slanting surface or a tapered surface) interposed therebetween. In this case together with the back surface shape of the first lens 406, the front surface shape of the first lens 406, such as the optical surface A, the slanting surface 406B on the outer circumference side thereof, and the spacer section 406C, are simultaneously formed with a transparent resin material.

As illustrated in FIG. 3(b), both the front surface and the back surface of the second lens 407 are provided with a bottom section 407E (or a bottom surface section) for arranging an adhesive thereon, on a further outer circumference side of a planarized spacer section 407D (protruded section), which is annularly protruded surrounding an optical surface A of a center portion thereof, with a step section (a slanting section) interposed therebetween.

An adhesive 409 is arranged in a space portion surrounded by the bottom surface sections 406E and 407E, which are on the further outer circumference side of the respective planarized surfaces of the spacer section 406D on the underside of the upper first lens 406 and the spacer section 407D on the upper side of the lower second lens 407. Thus, the first lens 406 and the second lens 407 are adhered with each other. In this case, a UV curing resin is used for the adhesive 409.

The annular slanting surface 406B of the first lens 406, and the annular slanting surface 402C inside an aperture opening B of the light shielding holder 402 are guided together, so that the upper spacer section 406C and slanting surface 406B of the first lens 406 are engaged with the slanting surface 402C of the light shielding holder 402. In order to facilitate to house the lens module 408 into the light shielding holder 402 during the assembly, there is a gap of 30 μm to 100 μm between the inner surface of the light shielding holder 402 and the external side surface of the lens module 408. There is also a gap of 0 μm to 20 μm between the slanting surface 406B of the first lens 406 and the slanting surface 402C on the inner side of the light shielding holder 402. The engaging angle θ of the slanting surface 406B is approximately between 30 and 80 degrees, and preferably approximately between 45 to 60 degrees. Thus, the positional accuracy between the optical surface A of the first lens 406 and the aperture opening B of the light shielding holder 402 becomes as highly accurate as ±10 μm.

A light shielding plate 410 is interposed between the spacer section 406D on the underside of the upper first lens 406 and the spacer section 407D on the upper side of the lower second lens 407. The light shielding plate 410 includes a through hole formed at the center portion to correspond to the optical surface. In addition, black dyed stainless steel (SUS), black PET or a PI substrate with black metal sputtered or deposited on its surface may be used for the light shielding plate 410. The black dyed light shielding plate of stainless steel can be formed as thin as 100 μm or less in thickness, which reduces the variation in size in the thickness direction. For example, when a stainless steel light shielding plate with the thickness of 20 μm is used, the thickness variation will be approximately ±2 μm, which is a variation within an optically acceptable range. The light shielding plate 410 is directly put between the spacer section 406D and the spacer section 407D, and the light shielding plate 410 is also thin, which causes almost no variation in the thickness direction of the lens module 408 and causes little optical influence.

As described above and as illustrated in a circle contacting section G in FIG. 2, the lens space between the first lens 406 and the second lens 407 as well as the thickness of the lens module 408 are controlled by the contact of the respective planarized surfaces of the annular protruded portions of the spacer sections 406D and 407D. That is, the lens space is determined by the contacting surfaces (spacer sections 406D and 407D) of the first lens 406 and the second lens 407 and the thickness of the light shielding plate 410. The adhesive 409 is arranged in the space portion (gap portion) surrounded by the bottom surface sections 406E and 407E, which are on the further outer side of the contacting surfaces, and the first lens 406 and the second lens 407 are adhered by the adhesive 409. As a result, even if a large amount of the adhesive 409 is provided, the adhesive 409 will spread only within the gap, thereby no harmful influence is made depending on the variation of the thickness or amount of the adhesive 409. As a result, the lens space is stabilized, and the optical characteristics of the lens module 408 are also stabilized. In this case as well, a later-described vent hole 409A can be provided in the adhesive 409, which is arranged in the periphery of the optical surface A, to prevent the adhesive 409 from being peeled off during the reflow.

As illustrated by an adhesive section H in the circle of FIG. 2, the light shielding plate 410, which is a quadrilateral (or a disc) shape in plan view, includes a cut section 411e, which is formed by cutting off part of the outer circumference portion of the light shielding plate 410. The cut section 411e does not reach as far as the outer circumference end of the first lens 406 or the second lens 407, and creates a gap. The reason why the cut section 411e is provided is first to prevent the light shielding plate 410 from shielding UV light to the adhesive 409 so that a UV light curing resin can be used for the adhesive 409, and second to reduce the area to be cut in the light shielding plate 410. If a thermosetting resin is used for the adhesive 409, there is a possibility of the lenses to be deformed due to the difference in the extension between the upper and lower lenses during the heat treatment. If a UV light curing resin is used for the adhesive 409, the adhesive 409 can be cured by UV light at a low temperature, which provides the dimensional stability of the overall lens module 408.

If a stainless steel plate material (SUS), for example, is used for the light shielding plate 410 and it is cut using a dicing blade or a wire, the edge of the blade becomes dull and the cutting surface becomes rough. Therefore, it is desirable to reduce the cutting area as much as possible. In order to reduce the area to be cut in the light shielding plate 410, cut guiding holes are provided. For example, in order to facilitate the simultaneous cutting, a case where each cut guiding hole is a rectangular hole is illustrated in FIG. 7(a), and a case where the cut guiding holes include a cross shape hole and an L shape hole is illustrated in FIG. 7(b).

Hereinafter, a first lens wafer, a light shielding plate wafer and a second lens wafer will be described, and a dicing line DL will also be described using the light shielding plate wafer.

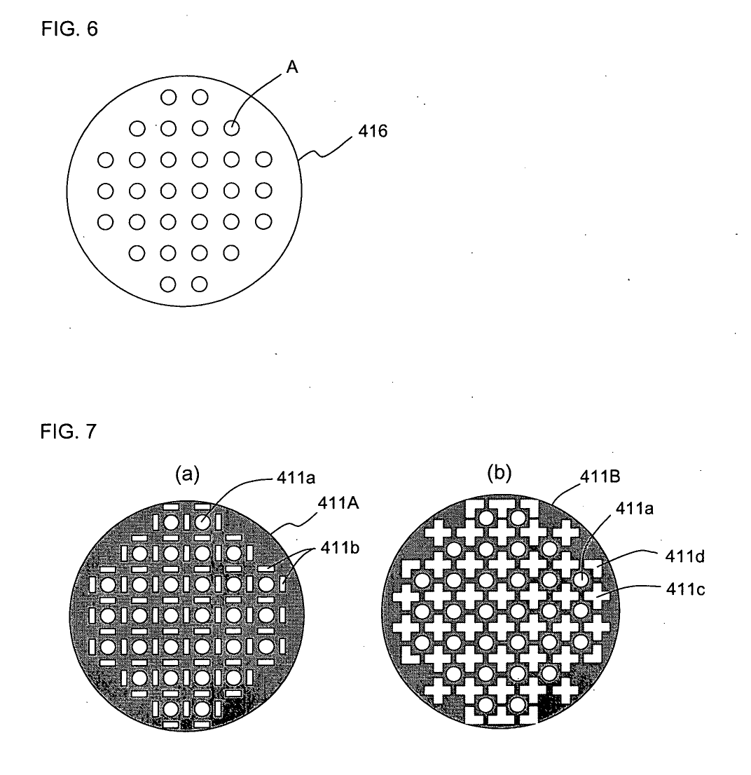

FIG. 6 is a plan view illustrating an example of a first lens wafer 416. In FIG. 6, a plurality of optical surfaces A are arranged equally both lengthwise and widthwise in the first lens wafer 416. In practice, a greater number of the optical surfaces A are arranged in a matrix.

FIG. 7 is a plan view illustrating an example of a light shielding plate wafer 411, where FIG. 7(a) is a view illustrating a case where the cut guiding hole is a rectangular hole, and FIG. 7(b) is a view illustrating a case where the cut guiding hole include a cross shape hole and an L shape hole. In FIGS. 7(a) and 7(b), a plurality of lens openings 411a are arranged equally both lengthwise and widthwise. In practice, a greater number of the lens openings 411a are arranged in a matrix. The lens openings 411a are formed as many as the number of the optical surfaces A, corresponding to the position of the optical surfaces A in FIG. 6. In the periphery of the lens openings 411a and between the adjacent lens openings 411a, rectangular holes 411b in FIG. 7(a) or cross shape holes 411c and L shape holes 411d in FIG. 7(b) are formed, as cut guiding holes to facilitate the simultaneous cutting. FIG. 9(a) and FIG. 9(b) respectively correspond to FIG. 7(a) and FIG. 7(b).

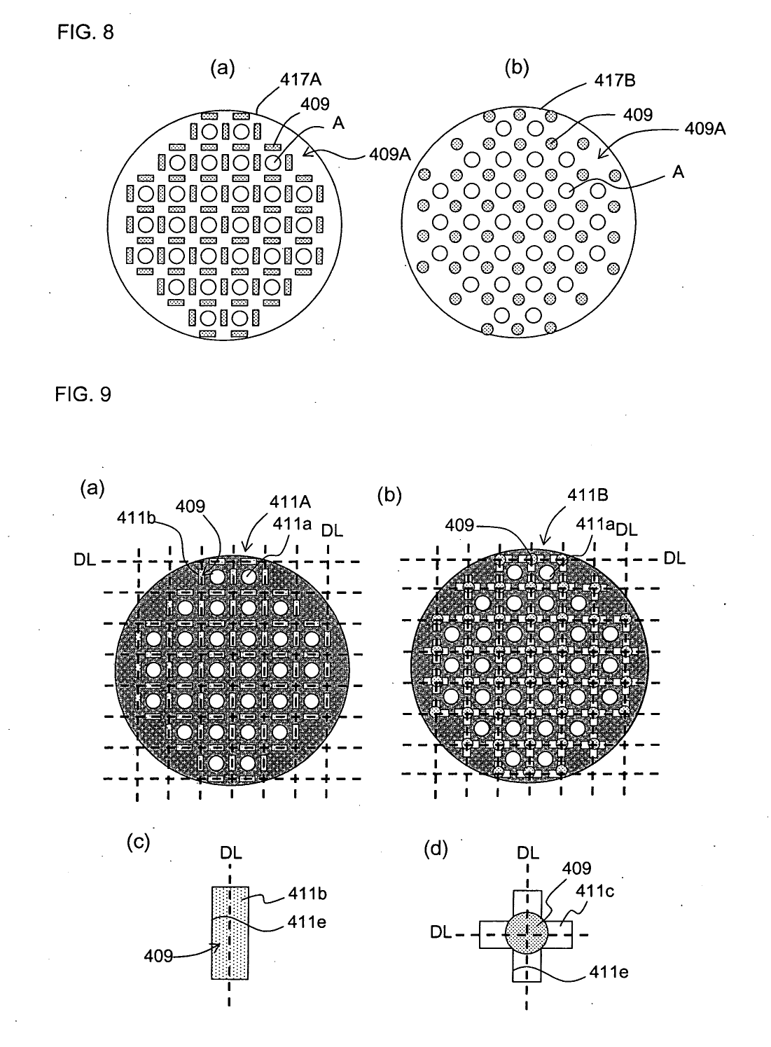

FIG. 8 is a plan view illustrating an example of a second lens wafer 417, where FIG. 8(a) is a plan view of a second lens wafer 417A, illustrating a state where the adhesive 409 is applied in accordance with the cut guiding holes of a light shielding plate wafer 411A being a rectangular hole, and FIG. 8(b) is a plan view of a second lens wafer 417B, illustrating a state where the adhesive 409 is applied in a circular shape in accordance with the cut guiding holes of a light shielding plate wafer 411B being a cross shape hole, a T shape hole and an L shape hole.

FIGS. 9(a) and 9(b) respectively illustrate the positional relationship between the cut guiding holes for facilitating the simultaneous cutting and the dicing lines DL, in each light shielding plate wafer in FIGS. 7(a) and 7(b). FIG. 9(c) is an enlarged view of a rectangular hole 411b in FIG. 9(a). FIG. 9(d) is an enlarged view of a cross shape hole 411c in FIG. 9(b).

In FIGS. 9(a) and 9(c), when the light shielding plate wafer 411A is laid on top of the second lens wafer 417A, the position of the rectangular holes 411b corresponds to that of the adhesives 409. The rectangular hole 411b, which is a cut guiding hole, is cut along the widthwise center line, or the dicing line DL, to be a cut section 411e. In FIGS. 9(b) and 9(d), when the light shielding plate wafer 411B is laid on top of the second lens wafer 417B, the position of the center portion of the cross shape hole 411c, for example, corresponds to that of the circular shape adhesive 409. The cross shape hole 411c, which is a cut guiding hole, is cut along the widthwise center line, or the dicing line DL, to be an L shape cut section 411e along a corner portion.

Accordingly, the individualized light shielding plate 410 is provided with the lens opening 411a at the position corresponding to the respective optical surfaces A of the first lens 406 and the second lens 407. The individualized light shielding plate 410 also includes the cut section 411e, which is obtained by cutting off part of the outer circumference edge of the light shielding plate 410. The cut section 411e is either formed at the four sides of the quadrilateral in a plan view, excluding the corner portions, or formed at the four corner portions. The cut section 411e at the four corner portions is either in a ¼ circular shape, which is a remainder of the circular hole after being cut crosswise as previously described, or in an L shape along a corner portion, which is a remainder of the cross shape hole, T shape hole and L shape hole after being cut.

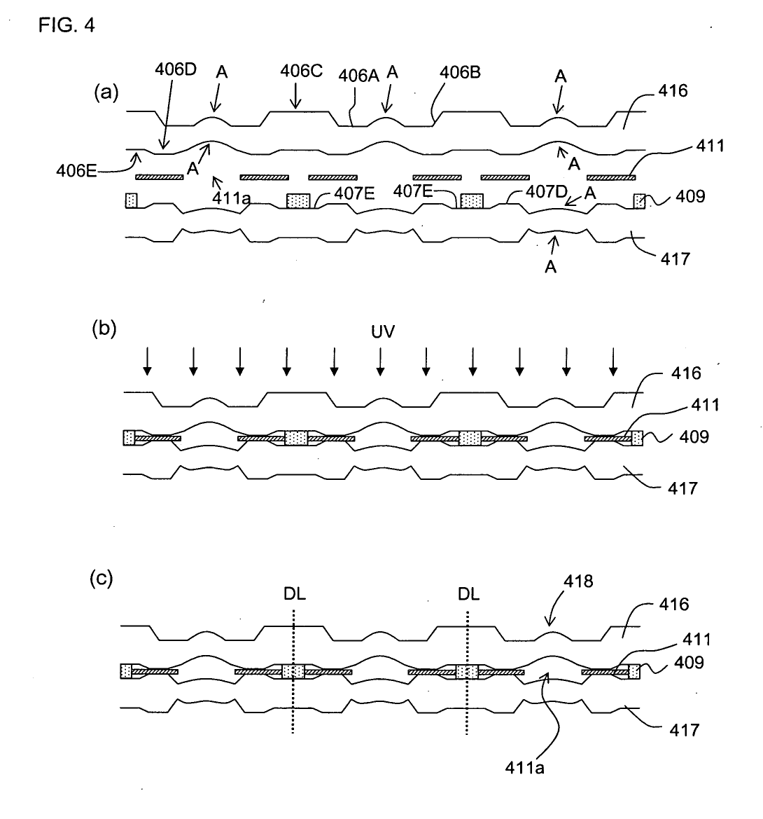

Next, a case will be described where the first lens wafer 416, the light shielding plate wafer 411, and the second lens wafer 417 are modularized to manufacture a lens wafer module 418 to be described later, with reference to FIGS. 4(a) to 4(c).

FIGS. 4(a) to 4(c) are each an essential part longitudinal cross sectional view illustrating each manufacturing step in a case where the first lens wafer 416 and the second lens wafer 417 are modularized to manufacture the lens wafer module 418.

First, in an adhesive applying step in FIG. 4(a), the adhesive 409 is applied, through a nozzle of a dispenser, on the bottom section 407E along dicing lines DL in a grid form, of the second lens wafer 417 (see FIG. 9), as illustrated in FIGS. 8(a) and 8(b). The second lens wafer 417 includes a plurality of second lenses 407 having the optical surfaces A arranged in a matrix therein. At this stage, as illustrated in FIG. 8(a), the adhesive 409 may be arranged in a rectangular shape at the four peripheral sides excluding the four peripheral corners (vent hole 409A) of the optical surface A. In this case, the four peripheral corner portions of the optical surface A become the vent holes 409A.

As illustrated in FIG. 8(b), the adhesive 409 may also be arranged in a quadrilateral or circular shape at only the four peripheral corners of the optical surface A. In this case, the four peripheral sides of the optical surface A become the vent holes 409A.

In this embodiment, the adhesive 409 is applied on the bottom section 407E between the second lenses 407 on the surface of the second lens wafer 417; however, without the limitation to this, the adhesive 409 may be applied on the bottom section 406E between the first lenses 406 on the back surface of the first lens wafer 416. Alternatively, the adhesive 409 may be applied on a predetermined position of the light shielding plate wafer 411. The predetermined position of the light shielding plate wafer 411 is the position of the cut guiding hole corresponding to the bottom section 406E and the bottom section 407E.

Next, in a combining step in FIG. 4(b), each optical axis of the optical surface A of each first lens 406 of the first lens wafer 416 is aligned to correspond with each optical axis of the optical surface A of each second lens 407 of the second lens wafer 417. Further, each center of the lens opening 411a of the light shielding plate wafer 411 is aligned to correspond with each optical axis of the optical surface A. Subsequently, the upper first lens wafer 416 and the lower second lens wafer 417, which are formed in a wafer scale, are combined with the adhesive 409 and the light shielding plate wafer 411 interposed therebetween to make them modularized. Thereafter, ultraviolet rays (UV) are emitted from above the wafer to cure the adhesive 409. In this case, although the light shielding plate wafer 411 is adhered by the adhesive 409, the light shielding plate wafer 411 need not be adhered by the adhesive 409, being separated from the adhesive 409, as will be described later in detail.

As described above, it is preferred to use a UV curing resin for the adhesive 409. The reason is that if a thermosetting resin is used for the adhesive 409, there will be a difference in the extension between the first lens wafer 416 and the second lens wafer 417 during the heat treatment and the positions of the upper and lower, first and second lenses 406 and 407 may be shifted from each other. It is noted that a resin which is cured by either of UV light or heat is effective as the adhesive 409. In this case, the resin portion hidden by the light shielding plate wafer 411 can be cured by heat. Therefore, when the position of the upper and lower, first and second lenses 406 and 407 is fixed first by the UV resin curing and the subsequent heat treatment is performed, it will be difficult for the positions of the upper and lower, first and second lenses 406 and 407 to be shifted.

Subsequently, as illustrated in a cutting step in FIG. 4(c), a cut retaining tape (not shown) is adhered on the front surface side of the plurality of first lenses 406 of the first lens wafer 416, or on the back surface side of the plurality of second lenses 407 of the second lens wafer 417, of a wafer scale. A cut protecting tape (not shown) may also be adhered on the opposite surface side of the cut retaining tape. Further, the lens wafer module 418 is simultaneously cut along the dicing lines DL indicated by the dotted lines to be individualized into the lens modules 408.

A wafer-formed transparent support substrate (a substrate prior to being individualized into each transparent support substrate 405), such as a glass plate, is adhered and fixed by the resin adhesive layer 404 to cover the upper part of the image capturing element wafer 401, and an image capturing element wafer unit is manufactured. The image capturing element wafer unit is simultaneously cut along the dicing lines DL to be individualized into image capturing element chip modules 412 in FIG. 5.

Further, as illustrated in an image capturing element module assembling step in FIG. 5, the light shielding holder 402 is placed upside down so that the opened portion is placed upward. The lens module 408 is inserted into the light shielding holder 402 with the side of the first lens 406 facing in to engage the annular slanting surface 406B of the first lens 406 with the annular slanting surface 402C of the light shielding holder 402. Subsequently, owing to the weight of the lens module 408 itself, the annular slanting surface 406B of the first lens 406 and the annular slanting surface 402C on the inner side of the aperture opening B of the light shielding holder 402 are guided together, so that the spacer section 406C on the upper side of the first lens 406 is engaged accurately with the bottom surface section 402B of the light shielding holder 402. Further, a side wall of the lens module 408 is fixed inside the light shielding holder 402 using an adhesive or the like. Subsequently, the transparent support substrate 405 side of the image capturing element chip module 412 is placed on the step section 402A of the light shielding holder 402 and the side wall of the image capturing element chip module 412 is fixed to the light shielding holder 402 using an adhesive or the like. The adhesive fixes the side wall and the light shielding holder 402 so that the distance and horizontality are accurate between the lens module 408 and the image capturing elements. As a result, the image capturing element module 400 can be manufactured.

As described above, the manufacturing method of the image capturing element module 400 includes: a lens module assembling step and an image capturing element chip module assembling step. In the lens module assembling step, the lens module 408 is inserted from the upper first lens 406 side into the opening side of the light shielding holder 402, and owing to its weight, the annular slanting surface 406B of the upper most first lens 406 is guided to the annular slanting surface 402C on the inner side of the aperture opening B of the light shielding holder 402 to position the aperture opening B of the light shielding holder 402 and the optical surface A of the first lens 406. In the image capturing element chip module assembling step, the image capturing element chip module 412, in which the transparent support substrate 405 is adhered and fixed to cover the upper part of the image capturing element 403, is fixed inside the light shielding holder 402 by positioning the image capturing element 403 and the optical surface A. Thus, the lens or lens module 408 and the image capturing element chip module 412 are positioned and fixed inside the light shielding holder 402 to obtain the image capturing element module 400.

As described above, the lens module 408 is inserted half way through into the light shielding holder 402, which functions as a light shielding cover. Thereafter, the lens module 408 is dropped to be positioned accurately at the engaging section (annular slanting surfaces 402C and 406B) along the slanting surface. Thereafter, the image capturing element chip module 412 is mounted inside the light shielding holder 402.

Although a parts conveying device with positioning accuracy of approximately 10 μm is extremely expensive, a parts conveying device with positioning accuracy of approximately 30 μm is relatively inexpensive. Therefore, the following is possible: up to the positioning with positioning accuracy of approximately 30 μm, the lens module 408 is brought to the light shielding holder 402 to be inserted, and thereafter, the lens module 408 is dropped so that the lens module 408 can be positioned accurately along the engaging section (annular slanting surfaces 402C and 406B) of the light shielding holder 402.

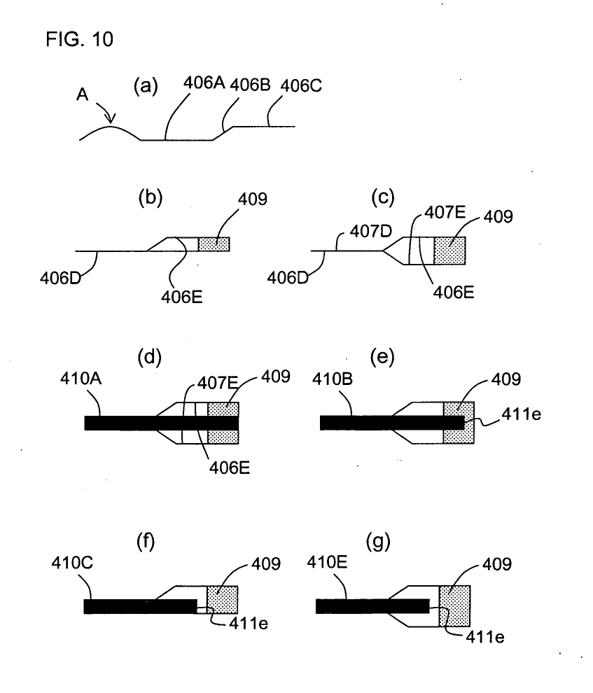

FIG. 10 is a diagram for describing a case where the light shielding plate wafer 411A in FIG. 9(a) is used and a case where it is not used, where FIG. 10(a) is an essential part cross sectional view of a front surface shape of the first lens 406, FIG. 10(b) is an essential part cross sectional view of a back surface shape thereof in a case where the first lens 406 is fixed by the adhesive 409 on a planarized section without a bottom section, FIG. 10(c) is an essential part cross sectional view of a joint surface of the first lens 406 and the second lens 407, FIGS. 10(d), 10(e) and 10(g) are each an essential part cross sectional view of a joint surface in a case where the light shielding plate 410 is directly put between the first lens 406 and the second lens 407, and FIG. 10(f) is an essential part cross sectional view of a joint surface in a case where the light shielding plate 410 is directly put between the first lens 406 and a planarized section without a bottom section.

FIGS. 10(b) and 10(c) illustrate a case where the light shielding plate 410 is not used. In FIG. 10(b), the spacer section 406D of the first lens 406 is directly contacting the planarized section without a bottom section to stabilize the lens space, and the adhesive 409 is arranged in a space portion of the bottom surface section 406E on the outer circumference side of the spacer section 406D. In this case, the combination of the planarized section without a bottom section and the first lens 406 includes, for example, a combination of the second lens 407 without a bottom section and the first lens 406 with a bottom section; and a combination of a transparent support body, such as a glass plate, and the first lens 406 with a bottom section, and the like.

In FIG. 10(c), the spacer section 406D of the first lens 406 is directly contacting the spacer section 407D of the second lens 407 to stabilize the lens space, and the adhesive 409 is arranged in a space portion between the bottom surface sections 406E and 407E on the outer circumference side of the spacer sections 406D and 407D.

In addition, FIGS. 10(d) to 10(g) illustrate a case where the light shielding plate 410 is used. FIG. 10(d) illustrates a case where a light shielding plate 410A extending up to the cutting position is used. FIG. 10(e) illustrates a case where a light shielding plate 410B being shorter than the light shielding plate 410A and is positioned inside the adhesive 409 (where a cut guiding hole is included).

FIGS. 10(f) and 10(g) respectively illustrate cases where light shielding plates 410C and 410E, which are separated from the adhesive 409, are used.

The advantages and disadvantages of the cases illustrated in FIGS. 10(d) to 10(g) will be described hereinafter.

In FIG. 10(d), the outer circumference section of the light shielding plate 410A is extended precisely up to the cutting outer circumference, which is excellent in the light shielding effect. With regard to the cutting of the light shielding plate 410A, it is not favorable because the cutting area increases. Furthermore, since the different materials, that is, the lens and the light shielding plate 410A, are adhered with each other by the adhesive 409, there is a possibility of the adhesive 409 peeling off at the interface between the light shielding plate 410A or the lens bottom section during heat treatment of reflow, for example. In FIG. 10(e), although the light shielding effect slightly decreases since there is a gap (cut section 411e) with the light shielding plate 410B compared to the light shielding plate 410A in FIG. 10(d), the cutting area is decreased, which improves the cutting effect. It becomes difficult for the adhesive 409 to be peeled off since there is a portion where the adhesion is made between the lenses and the adhesive 409 through the gap (cut section 411e).

In FIGS. 10(f) and 10(g), although the light shielding effect is further decreased compared to the light shielding plate 410B in FIG. 10(e) since there is a large gap (cut section 411e), the cutting effect is equal and the peeling resistance effect is further improved since there are more portions where the adhesion is made only by the lenses and the adhesive 409.

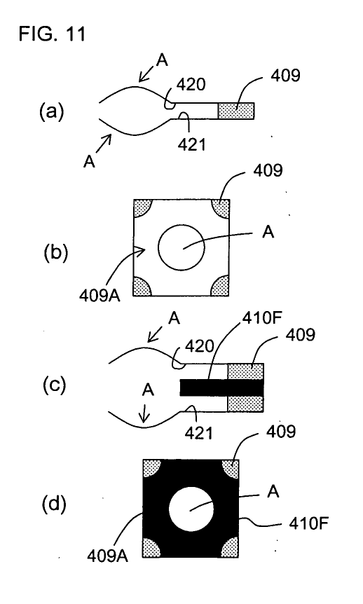

An example of a case where the spacer section 406D of the first lens 406 does not directly contact the spacer section 407D of the second lens 407, and a vent hole 409A is provided during the reflow to prevent the resin from being peeled off, will be described with reference to FIGS. 11(a) to 11(d).

FIG. 11 is a diagram for describing a case where the spacer section of the first lens does not directly contact the spacer section of the second lens, where FIG. 11(a) is an essential part cross sectional view of a lens joint surface of a case where a light shielding plate 410F is not used, FIG. 11(b) is a plan view thereof, FIG. 11(c) is an essential part cross sectional view of a lens joint surface of a case where the light shielding plate 410F is used, and FIG. 11(d) is a plan view thereof.

As illustrated in FIGS. 11(a) to 11(d), the adhesive 409 is arranged in a space portion surrounded by a planarized section on a further outer circumference side of a planarized surface of a spacer section 420 of the upper optical element, and a planarized section continuing on a further outer circumference side of a planarized surface of a spacer section 421 of the lower optical element. In this case, the respective planarized surfaces of the spacer section 420 of the upper optical element do not directly contact the spacer section 421 of the lower optical element.

In addition, as illustrated in FIGS. 11(c) and 11(d), of the plurality of optical elements, the light shielding plate 410F is interposed between the respective planarized surfaces of the spacer section 420 of the upper optical element and the spacer section 421 of the lower optical element. However,, the light shielding plate 410F does not contact either of the spacer section 420 or 421. Instead, the light shielding plate 410F connects with the spacer sections 420 and 421 with the adhesive 409 interposed therebetween. In this case, the adhesive 409 is arranged at the position of the cut guiding hole to adhere the light shielding plate 410F and the upper and lower lenses; however, the adhesive 409 is not limited to be arranged at the position of the cut guiding hole of the light shielding plate 410F. The adhesive 409 may also be arranged between the light shielding plate 410F and the upper lens and between the light shielding plate 410F and the lower lens.

According to Embodiment 1 as described above, the spacer section 406C is provided from the planarized section 406A with the slanting surface 406B interposed therebetween, on the outer circumference side of the optical surface A of the first lens 406 facing the aperture opening B of the light shielding holder 402; on the inner surface of the back side of the aperture opening of the light shielding holder 402, the planarized bottom surface 402B is provided with the slanting surface 402C interposed, facing the slanting surface 406B of the first lens 406; and the slanting surface 406B of the first lens 406 is guided by the slanting surface 402C of the light shielding holder 402, so that the spacer section 406C is engaged with the bottom surface 402B. As described above, the annular slanting surface 406B of the first lens 406 and the annular slanting surface 402C on the inner side of the light shielding holder 402 are guided together, so that the protruded annular slanting surface is engaged with the concave annular slanting surface. As a result, the lens module 408 is moved along the engaging section of the light shielding holder 402 so as to position the aperture opening B of the light shielding holder 402 and the optical surface A of the first lens 406 with high accuracy. Thereby, it becomes possible to prevent the misalignment or tilting of the lens optical axis C of the optical surface A relative to the aperture opening B of the light shielding holder 402 and the center of the aperture opening B, and make the optical characteristics favorable.

In addition, according to Embodiment 1, the upper first lens 406 and the lower second lens 407 are housed within the light shielding holder 402; the light shielding plate 410 is interposed between at least the respective planarized surfaces of the spacer section 406D of the upper first lens 406 and the spacer section 407D of the lower second lens 407; and the light shielding plate 410 includes the opening 411a at the position corresponding to the optical surface A of the optical element, and includes the cut section 411e, which is formed by cutting off part of the outer circumference portion of the light shielding plate 410. As described above, the light shielding plate 410 is made thin, so that the misalignment between the lenses can be further controlled to make the optical characteristics favorable. In addition, the cut section 411e is included, which is formed by cutting off part of the outer circumference portion of the light shielding plate 410, so that the cutting area is reduced and the simultaneous cutting can be better performed.

In addition, since the outer circumference section of the light shielding plate 410 does not reach the outer circumference ends of the first lens 406 and the second lens 407 and a gap is made by the cut section 411e, the light shielding plate 410 does not shield the UV light to the adhesive 409. As a result, it becomes possible to prevent the lenses from being deformed due to the difference in the extension between the upper and lower lenses during the conventional heat treatment. This provides dimensional stability to the overall lens module 408.

### Embodiment 2

In Embodiment 1 above, described is the case where the annular slanting surface of the optical element forms a concave section and the annular slanting surface of the light shielding holder forms a convex section, that is to say, the case where the concave annular slanting surface 406B of the first lens 406 and the convex annular slanting surface 402C protruded toward the inside of the aperture opening B of the light shielding holder 402 are guided together, so that the lens module 408 and the light shielding holder 402 are positioned with high accuracy. In Embodiment 2, a case will be described where the annular slanting surface of the optical element forms a convex section, and the annular slanting surface of the light shielding holder forms a concave section, that is to say, a case where the first lens side includes a convex annular slanting surface, and the light shielding holder side includes a concave annular slanting surface, which is concaved on the inner side of the aperture opening.

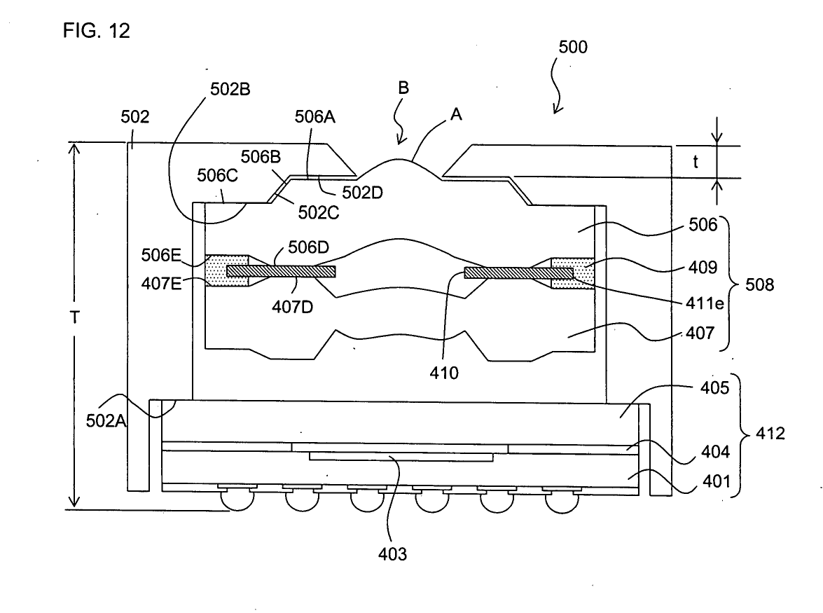

FIG. 12 is a longitudinal cross sectional view illustrating an exemplary detailed structure of an image capturing element module 500 according to Embodiment 2. It is noted that the same reference numerals are provided for those structural members which have the same functional effects as those in FIG. 2.

As illustrated in FIG. 12, the image capturing element module 500 according to Embodiment 2 includes: an image capturing element chip 401, as an electronic element, the image capturing element chip 401 including an image capturing element 403 arranged on the center portion thereof, and the image capturing element chip 401 including a plurality of light receiving sections for capturing an image of a subject; a resin adhesive layer 404 arranged in the periphery of the image capturing element 403 on the image capturing element chip 401; a transparent support substrate 405, such as a glass plate, covering the upper part of the image capturing element 403 and being adhered and fixed on the resin adhesive layer 404; and a lens module 508, as an optical element module, having a first lens 506 and a second lens 407 provided such that respective lens positions (position of respective optical surfaces A) correspond and align with the image capturing element 403. The image capturing element module 500 according to Embodiment 2 further includes a light shielding holder 502. The light shielding holder 502 arranges the image capturing element chip 401, resin adhesive layer 404 and transparent support substrate 405 on a step section 502A, and also arranges a lens module 508 on a bottom surface section 502B to shield outside light except for image capturing light. FIG. 12 illustrates a lens module 508 which is a single unit of a lens wafer module. In practice, this single unit lens module 508 is individualized by cutting the lens wafer module into a large number of lens modules 508. The lens module 508 is housed within the light shielding holder 502, and an individual piece of an electronic element (image capturing element unit 412 illustrated in FIG. 5) is arranged on a step section 502A in the light shielding holder 502 to manufacture the image capturing element module 500 (sensor module 10A, which will be later described with reference to FIG. 13).

In summary, different members herein are the light shielding holder 502 and the first lens 506. The first lens 506 includes a convex annular slanting surface 506B where an optical surface A and a planarized section 506A therearound are protruded. The light shielding holder 502 includes a concave annular slanting surface 502C which is concaved on the inner side of an aperture opening B. The slanting surface 506B, which is an annular convex part of the first lens 506, and the slanting surface 502C, which is an annular concave part on the inner side of the aperture opening B of the light shielding holder 502, are guided together, so that the slanting surface 506B, which is a protruded annular convex part, engages or contacts the slanting surface 502C, which is a concaved, annular concave part.

There is a gap of 30 μm to 100 μm between the inner surface of the light shielding holder 502 and the external side surface of the lens module 508 to facilitate the housing of the lens module 508 into the light shielding holder 502 during assembly. There is also a gap of 0 μm to 20 μm between the slanting surface 506B of the first lens 506 and the slanting surface 502C on the inner side of the light shielding holder 502. The engaging angle θ of the slanting surface 506B is approximately between 30 and 80 degrees, and preferably approximately between 45 to 60 degrees. Thus, the positional accuracy between the optical surface A of the first lens 506 and the aperture opening B of the light shielding holder 502 becomes as highly accurate as ±10 μm.

An adhesive 409 is arranged in the space portion surrounded by bottom surface sections 506E and 507E, which are on the further outer side of respective planarized surfaces of a spacer section 506D on the lower side of the upper first lens 506, and a spacer section 407D on the upper side of the lower second lens 407. As a result, the first lens 506 and the second lens 407 are combined with each other.

According to Embodiment 2 as described above, the spacer section 506C is provided from the planarized section 506A with the slanting surface 506B interposed therebetween, on the outer circumference side of the optical surface A of the first lens 506 facing the aperture opening B of the light shielding holder 502; on the inner surface of the back side of the aperture opening B of the light shielding holder 502, a planarized bottom surface 502D is provided with a slanting surface 402C interposed, facing the slanting surface 506B of the first lens 506; and the slanting surface 506B of the first lens 506 is guided by the slanting surface 502C of the light shielding holder 502, so that the planarized section 506A on the outer circumference side of the optical surface A is engaged to the bottom surface 502D. As described above, the annular convex slanting surface 506B of the first lens 506 and the annular concave slanting surface 502C on the inner side of the light shielding holder 502 are guided together, so that the protruded annular convex slanting surface is engaged with the concaved annular concave slanting surface. As a result, the lens module 508 can be positioned along the engaging section of the light shielding holder 502 with high accuracy. Thereby, it becomes possible to prevent the misalignment or tilting of the lens optical axis C of the optical surface A relative to the aperture opening B of the light shielding holder 502 and the center of the aperture opening B, and make the optical characteristics favorable.

In Embodiment 2, if approximately 0.2 mm or more cannot be secured for the thickness t of the bottom surface section 502D (ceiling section), there will be a problem of strength where sufficient rigidity will not be obtained. However, the image capturing element module 500 according to Embodiment 2 can be smaller (lower) than the image capturing element module 400 according to Embodiment 1 in an overall thickness T. The disadvantage of Embodiment 2 is that the optical surface A is protruded more than the spacer section 506C, which makes the optical surface Amore subject to scratches and dust during processes such as combining.

### Embodiment 3

FIG. 13 is a block diagram schematically illustrating an exemplary configuration of an electronic information device of Embodiment 3 of the present invention, using a solid-state image capturing apparatus including the sensor module 10 or 10A according to Embodiment 1 or 2 of the present invention in an image capturing section.

In FIG. 13, an electronic information device 90 according to Embodiment 3 of the present invention includes: a solid-state image capturing apparatus 91 for performing various signal processing on an image capturing signal from the sensor module 10 or 10A according to Embodiment 1 or 2 so as to obtain a color image signal; a memory section 92 (e.g., recording media) for data-recording a color image signal from the solid-state image capturing apparatus 91 after predetermined signal processing is performed on the color image signal for recording; a display section 93 (e.g., a liquid crystal display apparatus) for displaying the color image signal from the solid-state image capturing apparatus 91 on a display screen (e.g., liquid crystal display screen) after predetermined signal processing is performed on the color image signal for display; a communication section 94 (e.g., a transmitting and receiving device) for communicating the color image signal from the solid-state image capturing apparatus 91 after predetermined signal processing is performed on the color image signal for communication; and an image output section 95 (e.g., a printer) for printing the color image signal from the solid-state image capturing apparatus 91 after predetermined signal processing is performed for printing. Without the limitation to this, the electronic information device 90 may include at least any of the memory section 92, the display section 93, the communication section 94, and the image output section 95, other than the solid-state image capturing apparatus 91.

As the electronic information device 90, an electronic device that includes an image input device is conceivable, as described above, such as a digital camera (e.g., digital video camera or digital still camera), an image input camera (e.g., a monitoring camera, a door phone camera, a camera equipped in a vehicle including a back-view monitor camera, or a camera in a television telephone), a scanner, a facsimile machine, a camera-equipped cell phone device and a personal digital assistance (PDA).

Therefore, according to Embodiment 3 of the present invention, the color image signal from the solid-state image capturing apparatus 91 can be: displayed on a display screen properly by the display section 93, printed out properly on a sheet of paper using an image output section 95, communicated properly as communication data via a wire or a radio by the communication section 94, stored properly at the memory section 92 by performing predetermined data compression processing; and various data processes can be properly performed.

Without the limitation to the electronic information device 90 according to Embodiment 3, the electronic information device may be a pick up apparatus including the electronic element module of the present invention used in an information recording and reproducing section thereof. In this case, the optical element of the pick up apparatus is an optical function element that directs output light straight to be output and refracting and guiding incident light in a predetermined direction (e.g., a hologram optical element). In addition, as the electronic element of the pick up apparatus, a light emitting element for emitting output light (e.g., a semiconductor laser element or a laser chip) and a light receiving element for receiving incident light (e.g., a. photo IC) are included.

Although not specifically described in detail, the following is performed in Embodiment 1 or 2: one or a plurality of optical elements are housed within a light shielding holder; a slanting surface is provided on an outer circumference side of an optical surface of the optical element facing an aperture opening of the light shielding holder; a slanting surface is provided on an inner surface on the back side of the aperture opening of the light shielding holder in such a manner to face the slanting surface of the optical element; and the slanting surface of the optical element and the slanting surface of the light shielding holder are guided together, so that the aperture opening of the light shielding holder and the optical surface of the optical element are positioned. Thereby, the annular slanting surface of the first lens and the annular slanting surface on the inner side of the light shielding holder are guided together, so that the protruded annular slanting surface is engaged with the concaved annular slanting surface. As a result, The objective of the present invention can be achieved, which is to make it possible to prevent the misalignment and tilting of the lens optical axis C relative to the aperture opening B of the light shielding holder and the center of the aperture opening B, to make the optical characteristics favorable.

As described above, the present invention is exemplified by the use of its preferred Embodiments 1 to 3. However, the present invention should not be interpreted solely based on Embodiments 1 to 3 described above. It is understood that the scope of the present invention should be interpreted solely based on the claims. It is also understood that those skilled in the art can implement equivalent scope of technology, based on the description of the present invention and common knowledge from the description of the detailed preferred Embodiments 1 to 3 of the present invention. Furthermore, it is understood that any patent, any patent application and any references cited in the present specification should be incorporated by reference in the present specification in the same manner as the contents are specifically described therein.

### INDUSTRIAL APPLICABILITY

The present invention can be applied in the field of an optical element module, such as a lens module and an optical function element module, in which one or a plurality of optical elements are housed within a light shielding holder, and a manufacturing method thereof; an electronic element module obtained by modularizing the optical element module and an electronic element, and a manufacturing method thereof; and an electronic information device, such as a digital camera (e.g., a digital video camera or a digital still camera), an image input camera (e.g., a monitoring camera), a scanner, a facsimile machine, a television telephone device and a camera-equipped cell phone device, including the electronic element module as an image input device used in an image capturing section thereof. The annular slanting surface of the first lens and the annular slanting surface of the light shielding holder are guided together, and the protruded annular slanting surface is engaged with the concaved annular slanting surface. Therefore, it becomes possible to position, for example, the lens module consisting of the first lens and the second lens with high accuracy along the engaging section of the light shielding holder. As a result, it becomes possible to prevent the misalignment and tilting of the lens optical axis C relative to the aperture opening of the lens tube and the center of the aperture opening to make the optical characteristics favorable.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. An optical element module, in which: one or a plurality of optical elements are housed within a light shielding holder; a slanting surface is provided on an outer circumference side of an optical surface of the optical element facing an aperture opening of the light shielding holder; a slanting surface is provided on an inner surface on a back side of the aperture opening of the light shielding holder in such a manner to face the slanting surface of the optical element; and the slanting surface of the optical element and the slanting surface of the light shielding holder are guided together, so that the aperture opening of the light shielding holder and the optical surface of the optical element are positioned.

2. An optical element module according to claim 1, wherein: a spacer section is provided on the outer circumference side of the optical surface of the optical element facing the aperture opening of the light shielding holder, with a slanting surface interposed from a planarized section; a planarized bottom surface is provided on an inner surface of a back side of the aperture opening of the light shielding holder, with an interposed slanting surface facing the slanting surface of the optical element; and the slanting surface of the optical element is guided by the slanting surface of the light shielding holder, so that the bottom surface contacts the spacer section of the optical element.

3. An optical element module according to claim 1, wherein: a spacer section is provided on the outer circumference side of the optical surface of the optical element facing the aperture opening of the light shielding holder, with a slanting surface interposed from a planarized section; a planarized bottom surface is provided on an inner surface of a back side of the aperture opening of the light shielding holder, with an interposed slanting surface facing the slanting surface of the optical element; and the slanting surface of the optical element is guided by the slanting surface of the light shielding holder, so that the bottom surface contacts a planarized section on an outer circumference side of the optical surface.

4. An optical element module according to claim 1, wherein the slanting surface is an annular slanting surface.

5. An optical element module according to claim 1, wherein the annular slanting surface of the optical element forms a concave section, and the annular slanting surface of the light shielding holder forms a convex section.

6. An optical element module according to claim 1, wherein the annular slanting surface-of the optical element forms a convex section, and the annular slanting surface of the light shielding holder forms a concave section.

7. An optical element module according to claim 4, wherein the annular slanting surface of the optical element and the annular slanting surface of the light shielding holder slant 30 to 80 degrees relative to the planarized surface.

8. An optical element module according to claim 7, wherein the annular slanting surface of the optical element and the annular slanting surface of the light shielding holder slant 45 to 60 degrees relative to the planarized surface.

9. An optical element module according to claim 4, wherein there is a gap of 30 μm to 100 μm between an inner surface of the light shielding holder and an outer surface of the one or plurality of optical elements, which are quadrilateral in plan view.

10. An optical element module according to claim 4, wherein a gap between the annular slanting surface of the optical element and the annular slanting surface of the light shielding holder is 20 μm at its maximum.

11. An optical element module according to claim 1, wherein an adhesive is arranged only in a space portion surrounded by bottom sections provided, with interposed taper sections, on a further outer circumference side of respective planarized surfaces of the spacer section on the outer circumference side of the optical surface on a back surface of an upper optical element, and a spacer section on the outer circumference side of the optical surface on a front surface of a lower optical element, so that the upper optical element and the lower optical element are adhered with each other.

12. An optical element module according to claim 11, wherein: the adhesive is arranged only in the space portion surrounded by the bottom sections with the interposed taper sections; the adhesive is not arranged at least in a space portion surrounded by the upper and lower taper sections; and at least the space portion surrounded by the taper sections has enough space which prevents the adhesive from spreading to the spacer section by being pressed by the upper optical element and the lower optical element during adhesion.

13. An optical element module according to claim 11, wherein among the plurality of optical elements, a lens space between the upper optical element and the lower optical element is defined, together with an overall thickness, by direct contacting of the respective planarized surfaces of the spacer section of the upper optical element and the spacer section of the lower optical element.

14. An optical element module according to claim 11, wherein among the plurality of optical elements, a light shielding plate is interposed between at least the respective planarized surfaces of the spacer section of the upper optical element and the spacer section of the lower optical element.

15. An optical element module according to claim 14, wherein the light shielding plate includes an opening, which is provided at a position corresponding to the optical surface of the optical element, and includes a cut section, which is formed by cutting off part of an outer circumference edge thereof.

16. An optical element module according to claim 15, wherein the cut section is either provided at four sides of a quadrilateral in plan view excluding corner portions thereof, or formed at four corner portions thereof.

17. An optical element module according to claim 16, wherein the cut section at the four corner portions is either in a ¼ circular shape, or in an L shape along the corner portion.

18. An optical element module according to claim 1, wherein the optical surface, the slanting surface on the outer circumference side thereof, and the spacer section are simultaneously formed with a transparent resin material.

19. An optical element module according to claims 1, wherein the optical element is a lens.

20. An optical element module according to claim 1, wherein the optical element is an optical function element that directs output light straight to be output and refracting and guiding incident light in a predetermined direction.

21. A method for manufacturing an optical element module for manufacturing the optical element module according to claim 1, the method comprising an assembling step, in which an optical element module is inserted into an open side of the light shielding holder, from the side close to the uppermost optical element of the optical element module, and owing to a weight of the optical element module itself, a slanting surface of the upper most optical element and a slanting surface on an inner side of an aperture opening of the light shielding holder are guided together, so that the aperture opening of the light shielding holder and the optical surface of the optical element are positioned.

22. A method for manufacturing an optical element module according to claim 21, the method further including, prior to the assembling step:
a combing step for combing, by an adhesive, an upper lens wafer with a plurality of optical surfaces arranged thereon two dimensionally and a lower lens wafer with a plurality of optical surfaces arranged thereon two dimensionally, with a light shielding plate wafer interposed therebetween, in such a manner that optical axes of the upper and lower optical surfaces correspond to openings of the light shielding plate wafer, to manufacture an optical element wafer module;
a UV light emitting step of emitting UV light onto the adhesive to cure the adhesive; and
a cutting step of cutting the optical element wafer module simultaneously along dicing lines into individualized optical element modules.

23. An electronic element module, in which an image capturing element chip module is fixed in a light shielding holder of the optical element module according to claim 1, the image capturing element chip module including a transparent support substrate adhered and fixed thereto to cover an electronic element facing the optical surface of the optical element, and the image capturing element chip module being adhered by positioning the electronic element relative to the optical surface.

24. A method for manufacturing an electronic element module, the method including:
an optical element module assembling step using the method for manufacturing an optical element module according to claim 21; and
an electronic element chip module assembling step of fixing an electronic element chip module including a transparent support substrate adhered and fixed thereto for covering the electronic element, within the light shielding holder by positioning the electronic element facing the optical surface of the optical element, with the optical surface.

25. An electronic information device including an electronic element module, as a sensor module, in an image capturing section thereof, the electronic element module including the optical element module according to claim 19 provided therefor.

26. An electronic information device including an electronic element module in an information recording and reproducing section thereof, the electronic element module including the optical element module according to claim 20 provided therefor.
